(19) United States
(12) Patent Application Publication
(10) Pub. No.: US 2007/0219812 A1
(43) Pub. Date: Sep. 20, 2007

(54) Subscription-based multi-person emergency shelter method

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/381,265

(22) Filed: May 2, 2006

Related U.S. Application Data
(63) Continuation-in-part of application No. 11/384,037, filed on Mar. 17, 2006.
(63) Continuation-in-part of application No. 11/394,350, filed on Mar. 30, 2006.
(63) Continuation-in-part of application No. 11/279,333, filed on Apr. 11, 2006.
(63) Continuation-in-part of application No. 11/379,929, filed on Apr. 24, 2006.

(51) Int. Cl. G06Q 10/00

(52) U.S. Cl. 705/1

(57) ABSTRACT

Consideration-based private civil security subscriptions are accepted (101) from subscribers with respect to providing civilly-catastrophic event-based access to a secure multi-person emergency shelter (201). That shelter is then maintained (102) pending a need to permit subscription-based access to the secure multi-person emergency shelter in the event of a catastrophic event. This shelter can be as Spartan or as resplendent as desired and may be intentionally varied in this regard to reflect the needs and/or desires of different subscribers. The variety, strength, and effectiveness of the threat abatement accoutrements as characterize the shelter can also be varied as a function, at least in part, of locally recognized threats, subscriber requirements, and so forth.

### RELATED APPLICATIONS

This application comprises a continuation-in-part of four earlier filed patent applications:

SUBSCRIPTION-BASED PRIVATE CIVIL SECURITY FACILITATION METHOD as filed on Mar. 17, 2006 and having application Ser. No. 11/384,037; SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333; and

RADIATION SHELTER KIT APPARATUS AND METHOD as filed on Apr. 24, 2006 and having application Ser. No. 11/379,929;

the contents of which are fully incorporated herein by this reference.

This application relates to the following patent applications as were filed on even date herewith (wherein the contents of such patent applications are incorporated herein by this reference):

SUBSCRIPTION-BASED CATASTROPHE-TRIGGERED TRANSPORT SERVICES FACILITATION METHOD AND APPARATUS (8379/87821);

FRACTIONALLY-POSSESSED UNDERGROUND SHELTER METHOD AND APPARATUS (attorney's docket number 8379/87822); and

SUBSCRIPTION-BASED CATASTROPHE-TRIGGERED RESCUE SERVICES FACILITATION METHOD AND APPARATUS (8379/87824)

### TECHNICAL FIELD

This invention relates generally to emergency shelters.

### BACKGROUND

As powerful as the machinery of modern life appears, modern citizens are today perhaps more at risk of experiencing a serious disruption in their ability to prosper or even to survive en mass than is generally perceived. Genuine concerns exist regarding the threat of radiation (due, for example, to radioactive fallout created by an intentionally detonated nuclear device or as may result through inadvertence or accident), airborne harmful biological and/or chemical agents, and so forth.

Many people believe and trust that their government (local, regional, and/or national) will provide for them in the event of such an event. And, indeed, in the long view such is clearly a legitimate responsibility owed by any government to its citizens. That such is a consummation devoutly to be wished, however, does not necessarily make it so. To a large extent one may reasonably argue that governments have forsaken their responsibility to design, fund, implement, or even discuss an effective program capable of protecting large segments of their populations. Only a very few countries, such as Switzerland, make the ability to survive such events a discussed, funded regulated, and supported part of the civil fabric.

Many catastrophic events are survivable presuming one has access to a suitable emergency shelter. It is possible, of course, to retain the services of skilled shelter builders to thereby personally acquire such a shelter. Such an approach, however, presents a number of corresponding problems and issues. In general, such shelters often require excavation and the building of a below-ground facility. This, in turn, tends to be costly, is often impractical for a given interested party, and may cause considerable unwanted attention as well.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive at least some locally catastrophic events. Therein, however, lies something of a conundrum.

On the one hand, modern governments typically do little to proactively ensure the bulk survival (let alone the comfort) of their citizens in the face of most civilly-catastrophic events. On the other hand, attempting to take responsible actions to reasonably ensure one's own safety and security can become, in and of itself, a cost prohibitive and nearly full-time avocation that leaves little time to actually enjoy the conveniences and opportunities of modern life. Such individual actions may even be frowned upon by the greater part of society.

### BRIEF DESCRIPTION OF THE DRAWINGS

The above needs are at least partially met through provision of the subscription-based multi-person emergency shelter method described in the following detailed description, particularly when studied in conjunction with the drawings, wherein:

FIG. 1 comprises a flow diagram as configured in accordance with various embodiments of the invention;

FIG. 2 comprises a top plan schematic view as configured in accordance with various embodiments of the invention;

FIG. 3 comprises a side elevational schematic view as configured in accordance with various embodiments of the invention; and

FIG. 4 comprises a top plan schematic view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a secure multi-person emergency shelter is provided and consideration-based private civil security subscriptions are accepted from subscribers with respect to providing civilly-catastrophic event-based access to this secure multi-person emergency shelter. By one optional approach that shelter is then maintained pending a need to permit subscription-based access to the secure multi-person emergency shelter in the event of a catastrophic event.

This shelter can be as Spartan or as resplendent as desired and may be intentionally varied in this regard to reflect the needs and/or desires of different subscribers. The variety, strength, and effectiveness of the threat abatement accoutrements as characterize the shelter can also be varied as a function, at least in part, of locally recognized threats, subscriber requirements, and so forth.

These teachings can be facilitated without dependency upon governmental oversight, participation, or control. The particular resources provided can vary with the needs and requirements of the authorized beneficiaries of the subscriptions. By these teachings an individual can take important steps to bring security into their lives without having to effectively become a full-time survivalist; such individuals can, in short, continue to enjoy their chosen vocations and standard of living knowing that, should a civilly-catastrophic event indeed be visited upon them, they will have extraordinary access to an emergency shelter that may prove critical to the sustainment of human life.

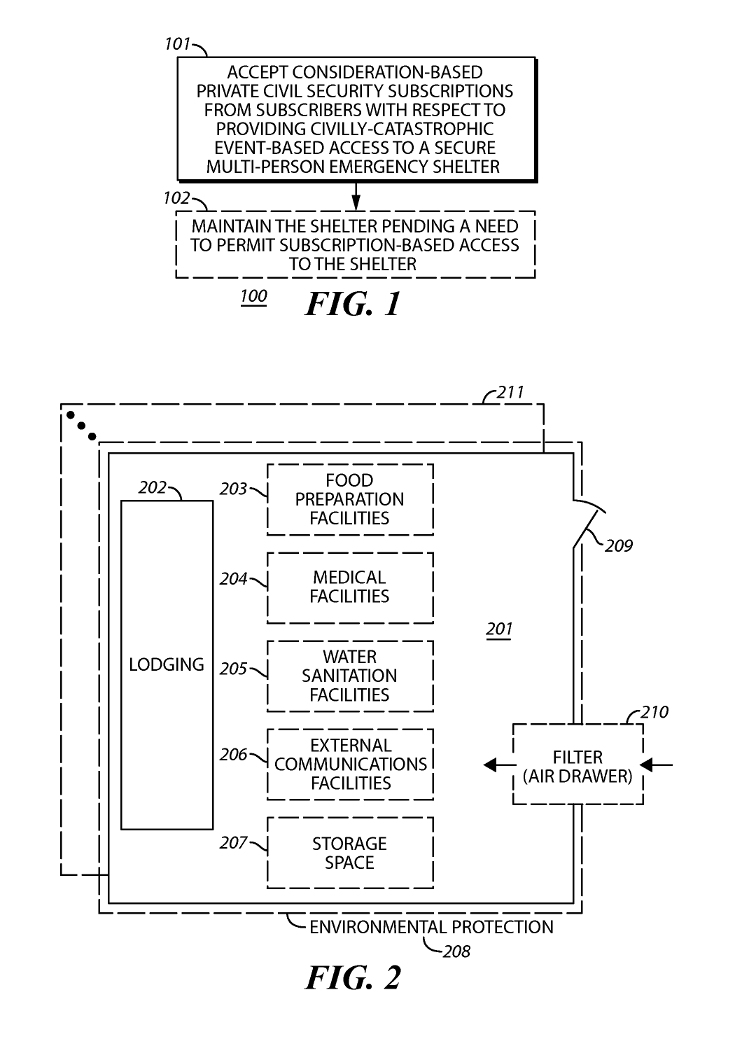

These and other benefits may become clearer upon making a thorough review and study of the following detailed description. Referring now to the drawings, and in particular to FIG. 1, an illustrative process 100 in accord with these teachings provides generally for accepting 101 consideration-based private civil security subscriptions from subscribers with respect to providing civilly-catastrophic event-based access to a provided secure multi-person emergency shelter.

This right of access can pertain, if desired, to a predetermined period during which such access pertains. For example, a given subscription can relate to providing access to the shelter for a predetermined period of time (such as a predetermined number of days such as 30 days, a one year period of time, and so forth) for a given individual, number of individuals, or the like. It would also be possible to provide for a dynamically determined or assessed consideration for such a subscription. For example, by one approach, one may assess the likelihood of one or more particular civilly-catastrophic events occurring during a particular subscription term. One may then base the consideration for a particular subscription, at least in part, on that likelihood. This would permit, for example, assessing a higher relative consideration for a subscription that is sought when tensions and concerns in this regard are running particularly high and vice versa.

By one approach, these subscriptions may be accepted by, for example, a for-profit business. By another approach a not-for-profit business (such as a membership-based entity) may be the appropriate entity to offer and accept such subscriptions.

As noted, these teachings provide for a subscription-based approach. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of-access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extend past the death of a named subscription beneficiary and further provides for testate and/or intestate transfer to an heir);

rights of access predicated upon a series of periodic payments (as where a subscription provides access rights during, for example, predetermined periods of time on a periodic basis as where a subscriber offers a payment on a-month-by-month basis to gain corresponding month-by-month access rights);

rights of access predicated upon a one-time payment (as may occur when a subscriber makes a single payment to obtain a time-based or event-based duration of access rights or, if desired, when a single payment serves to acquire a perpetual right of access that may be retained, transferred, inherited, or the like);

ownership-based rights of access (as may occur when the subscription provides for ownership rights that pertain to a portion of the shelter);

non-transferable rights of access (as may occur when the subscription, by its terms and conditions, prohibits transfer of the right of access from a first named beneficiary to another);

transferable rights of access (as may occur when the subscription, by its terms and conditions, permits, conditional or unconditional transfer of the right of access from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided or undivided co-ownership interest by and between multiple subscription beneficiaries with respect to a right to access); and/or non-ownership-based rights of access (as may occur when the subscription, by its terms and conditions, establishes the aforementioned right of access via, for example, a lease, rental, or borrowing construct).

If desired, a plurality of differentiated subscription opportunities can be offered in this regard. This plurality of differentiated subscription opportunities can correspond, for example, to providing access to differing shelter accommodations (and/or locations). As but one very simple illustration in this regard, such subscription opportunities can differ from one another at least with respect to cost. This, in turn, provides subscriber choice with respect to selecting a particular subscription that best meets their specific needs and/or budget limitations. For example, one subscription can provide for accessing a particular shelter and/or particular shelter amenities that, though viable, reflect a more economical and Spartan approach while another subscription might provide for choices and options that are more costly.

These teachings also readily encompass the notion of a given subscriber acquiring such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

As noted, these subscriptions relate to providing access to a multi-person emergency shelter in the event of a civilly-catastrophic event. Such access may be predicated, if desired, upon a requirement that the civilly-catastrophic event be one that persists in substantial form for more than a predetermined period of time (such as one hour, one day, one week, and so forth) or that causes at least a predetermined amount or degree of infrastructure impairment or other measurable impact of choice.

As used herein, civilly-catastrophic event will be understood to refer to an event that substantially disrupts a society's infrastructure and ability to provide in ordinary course for the at least one life-sustaining resource that is the subject of the subscription. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation of that interruption.

A civilly-catastrophic event can be occasioned by any of a wide variety of natural and/or human-caused disasters. Examples of natural disasters that are potentially capable of initiating a civilly-catastrophic event include, but are not limited to, extreme weather-related events (Such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based collisions (as with comets, large asteroids, and so forth), extreme environmental events (such as widespread uncontrolled fire or the like), and global or regional pandemics, to note but a few.

Examples of human-caused disasters capable of initiating a civilly-catastrophic event include both unintended events as well, unfortunately, as intentional acts of war, terrorism, madness or the like. Examples of human-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, and so forth.

Emergency shelters comprise a generally well-understood area of endeavor with various construction techniques, architectural choices, and materials options being known. Suitable shelters may be fully disposed above the ground, fully disposed within the ground, or partially located above the ground and partially located within the ground as desired. The present teachings are compatible for use with such already-existing shelters and likely may be used with shelter technology as may be developed hereafter. For the purpose of illustration and not limitation, and referring now to FIG. 2, certain approaches that may be taken with respect to providing such a shelter will be presented.

This illustrative multi-person emergency shelter 201 comprises, at least in part, a lodging area 202. This lodging area 202 may serve to provide lodging for authorized beneficiaries when taking shelter in the emergency shelter 201. This lodging area 202 can comprise built-in or free-standing sleeping accommodations or the like if desired. The lodging area 202 can be configured and arranged as desired to provide private-lodging accommodations, semi-private lodging accommodations, and/or common non-private accommodations. This lodging area 202 may optionally include such other facilities as may be desired. Examples include, but are not limited to:

personal hygiene facilities (including toilet anid bathing facilities);

personal storage space;

personal food preparation facilities;

personal external communications facilities; and

personal meeting facilities;

to note but a few.

As this shelter 201 comprises a multi-person shelter, it is likely that the shelter may be occupied by at least some beneficiaries that are not affiliated with one another. For example, a given shelter might be subscribed to by three families that each comprise four family members. With this in mind, the lodging area 202 can be partitioned to create private (or relatively private) areas to separately accommodate such unaffiliated groups/persons. Such areas can be demarked from one another using any suitable technique or mechanism.

By one simple approach, these areas are differentiated by agreement, instruction, and/or control without use of any physical barriers, walls, or the like (though relevant visual markings (for example, on the floor and/or ceiling) can be used to provide a visual cue as to these corresponding boundaries). By another approach, curtains, temporary panels, or the like can be used to differentiate these various areas from one another. By yet another approach permanent walls can be used to make the desired separations.

Other portions of the shelter 201 (which may or may not comprise one or more common areas as desired) can be configured and arranged to support such other functionality and/or purposes as may befit a particular application setting. The extent of such features can and will vary with such influences as a typical and/or total amount of time that the shelter is expected to be able to support emergency habitation, the kinds of threats the shelter is intended to protect against, and so forth. Some examples include, but are not limited to:

food preparation facilities 203 for the authorized beneficiaries (including, for example, cooking tools, utensils, pots and pans, serving ware, heating elements and enclosures, and so forth);

medical facilities 204 for the authorized beneficiaries (including, for example, first aid supplies, first responder supplies, equipment, and instructions, antibiotics and antiviral medicines, radiation sickness treatments, automatic external defibrillators, and chronic care equipment and/or supplies to ensure that a particular authorized beneficiary having particular needs in this regard is well tended during a time of residency in the shelter, to note but a few examples);

water sanitation facilities 205 for authorized beneficiaries (including, but not limited to, pre-positioned potable water, a water purifier, a water filter, a drain, and so forth);

external-communication facilities 206 for authorized beneficiaries (comprising equipment to permit a person or device within the shelter to communicate to another person, entity, or device that is external to the shelter, including but not limited to one-way and two-way wireless and non-wireless audio, video, and data communications); and

storage space 207 for authorized beneficiaries (including but not limited to private and/or commonly-shared food supplies, potable water, medical supplies, hygiene supplies, clothing items, towels, bed linens, food preparation items, communication items; and entertainment items, to again note but a few).

A primary purpose of such a shelter, of course, is to improve the likelihood that the authorized beneficiaries will survive a civilly-catastrophic event, preferably without incurring any attendant illness, injury, or other impediment to longer-term survival and prosperity. Relative security and threat abatement will therefore typically deserve attention when designing and providing a given shelter.

By one approach, access to the shelter can be controlled, at least in part, by use of a fence or other perimeter barrier that prevents unauthorized persons from accessing the shelter. Such a perimeter barrier may comprise a partially or wholly man-made structure or may comprise, at least in part, natural elements and obstacles of the local terrain and environs.

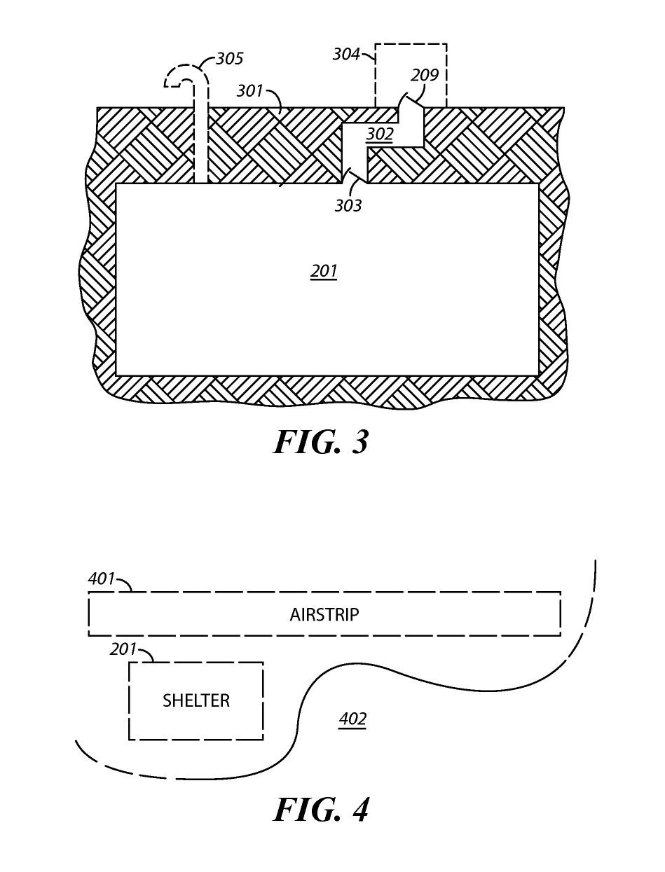

Security will typically benefit by use of controlled points of ingress/egress 209. Such points may comprise a sturdy, lockable, movable barrier that is configured and designed to withstand attempts by others to achieve unauthorized access to the shelter and to provide a measure of protection against other environmentally-borne threats as may be present in the external environs. By one approach, and referring momentarily to FIG. 3, when the shelter 201 comprises an underground shelter, this point of ingress/egress 209 can comprise a somewhat serpentine pathway 302 that may, for example, include multiple lockable movable barriers 303. At least one purpose served by a serpentine pathway 302 is to aid with radiation blockage by avoiding a pathway-coincident straight-line path by which radioactive material may engage the shelter. It may also be useful to provide an optional building 304 about the point of ingress/egress 209. Such a building 304 can serve to provide an additional measure of security as regards protecting the shelter from unauthorized access.

If desired, multiple points of ingress and/or egress may be provided. This may be appropriate, for example, for particularly large shelters. This may also be useful when seeking to provide alternative ways to leave a shelter. As but one example in this regard, an emergency escape hatch may be provided that is ordinarily covered with earth. Persons seeking to escape could open the hatch and then remove the dirt to effectively dig an escape route from the shelter. This could be useful in a situation where the primary means of ingress/egress has been damaged and/or blocked in some manner that prevents it from being opened from within the shelter.

With continued momentary reference to FIG. 3, to assist with protecting the authorized beneficiaries within the shelter 201 during a time of need, the shelter 201 may well comprise an underground shelter. When seeking to provide protection against radioactivity, of course, the usual design goal is to place considerable mass between the shelter inhabitants and the source of the radioactivity. As the depicted shelter 201 comprises an underground shelter, the shelter will have at least some benefits in this regard. To provide particularly effective protection in this regard, it may be useful to cover the shelter 201 with at least two meters of earth 301 (or more). This depth can vary, of course, with the nature of the earth itself, as a greater depth within less dense earth may be necessary to provide a same level of radiation blockage as a lesser depth within more dense earth.

By one approach such a shelter 201 can be provided with an independent source of breathable oxygen. When such is not the case, or when a back-up capability is also sought, an airway 305 can be provided to permit air to be taken in from above-ground to the below-ground shelter 201. In at least some cases, of course, this above-ground air may be dangerous in greater or lesser degrees to persons within the shelter 201. Therefore, and referring again to FIG. 2, a given shelter 201 may further optionally comprise protection, such as an air filter 210, from dangerous airborne contaminants (such as radiological contaminants, biological contaminants, and/or chemical contaminants) as may correspond, for example, to a civilly-catastrophic event. Various air filters are known in the art and require no further elaboration here.

If desired, this air filter 210 can further comprise an air drawer to draw air into the shelter 201. A variety of such air drawers are known in the art and include electrically powered air drawers, human powered air drawers, and so forth. By one approach this air drawer can be of sufficient size and power to create positive air pressure in the shelter 201 as compared to external ambient conditions. This, in turn, can aid in discouraging airborne contaminants from entering the shelter via whatever cracks, seams, and other openings may be present in the shelter's structure.

Such approaches as those described above can comprise a part of an overall environmental protection plan 208 for the shelter 201, the general purpose of which is to reduce or fully abate one or more external threats to the inhabitants of the shelter 201. At least some such threats, of course, will typically comprise extraordinary threats that are caused by, or otherwise attend or follow, the kinds of civilly-catastrophic events as can trigger the aforementioned right to access the shelter 201.

Other embellishments for such a shelter as are known in the art may also be considered if desired. Examples include, but are not limited to, auxiliary electric power supplies and sources, lighting, temperature and/or humidity control, water purification, and so forth. By yet another approach, such a shelter can provide private safe deposit box service for the authorized beneficiaries. This, in turn, would permit these beneficiaries with an option to pre-provision such a shelter with certain personal items of their choice and/or to have a safe place to store their own valuables upon arriving at the shelter during times of need.

In many application settings it will be useful to provide a plurality 211 of such shelters 201. By one approach this plurality of shelters 201 can each be positioned geographically remote from one another (to better assure, for example, a likelihood that at least one of the shelters will survive a particularly egregious civilly-catastrophic event). In such a case, of course, if desired the aforementioned subscriptions may provide civilly-catastrophic event-based access to more than one of the plurality of emergency shelters 201. For example, one or more of the authorized beneficiaries may have, via their corresponding subscription, a right to access any of the plurality of emergency shelters 201 during a time of need.

In some cases it may be useful to locate such a shelter at a considerable distance from major population centers. Such a location may improve the relative security of the shelter and may offer other benefits as well. In other cases, however, it may be useful to locate such a shelter relatively near, or even within, a corresponding population center. The latter may be preferable when anticipating civilly-catastrophic events that may occur in a devastating fashion with relatively little advance notice as relative proximity between the shelter and the authorized beneficiaries may be advantageous under such circumstances.

With reference to FIG. 4, if desired, such a shelter 201 can be located proximal to one or more of an airstrip, a helipad, an open territory that is suitable to accommodate receiving an airborne passenger-carrying vehicle, or even a port that is suitable to accommodate receiving a water-borne passenger-carrying vehicle. Such a location, of course, may be helpful when receiving authorized beneficiaries during a time of need. FIG. 4 illustrates, for example, such proximity as between an optional airstrip 401 and an optional water port 402 (as may comprise a part of a lake, a river, an ocean, or the like). By one approach, if desired, such an airstrip may be reserved for use only to receive such authorized beneficiaries.

Referring again to FIG. 1, this process 100 can then optionally provide for maintaining 102 the shelter pending a need to permit subscription-based access to the shelter in the event of a catastrophic event. This, of course, can comprise maintaining the resource on behalf of the subscriber and/or the authorized beneficiaries. The specifics of such maintenance will of course vary with respect to the nature of the resource or resources being maintained.

By one approach such maintenance can comprise at least one or more of:
ensuring that unauthorized persons do not access the shelter;
inspecting and/or testing the structural and operational integrity of the shelter and its constituent elements, components, and systems;
ensuring that pre-provisioned supplies are properly stored, fresh, and suitable for use should the need arise;
   to name but a few examples.

These teachings would also accommodate providing survival training to the authorized beneficiaries. Such training could comprise in-person, on-site training, live instructors, and/of previously prepared teaching resources such as, but not limited to, electronic learning resources. This training could include both general information regarding specific do's and don'ts as pertain to different kinds of civilly-catastrophic events as well as more specific information regarding specific actions that should be taken by the authorized beneficiaries with respect to successfully gaining access to and surviving within the shelter in times of need.

These teachings will also accommodate providing the authorized beneficiaries with a corresponding authorization mechanism by which they can effect their right of access to the shelter. This may comprise a mechanism that the beneficiary carries with them as personal property (such as an identification card) or, for example, a biometric-based identity authentication process that relies upon fingerprints, retinal patterns, or some other relatively unique aspect of the human body.

So configured, these teachings provide a highly flexible, efficient, cost-effective, and reliable way by which interested parties can secure for themselves an emergency shelter to which they may turn in response to unfortunately experiencing a civilly-catastrophic event. These teachings scale well and are applicable to modest shelters, opulent shelters, and everything in between. The subscription-based approach provided herein offers a highly leveragable construct by which credible protection against the unthinkable becomes possible.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing a secure multi-person emergency shelter;
accepting consideration-based private civil security subscriptions from subscribers with respect to providing civilly-catastrophic event-based access to the secure multi-person emergency shelter.

2. The method of claim 1 wherein the subscriptions comprise at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
fractionally-based rights of access;
non-ownership-based rights of access.

3. The method of claim 1 wherein the multi-person emergency shelter comprises, at least in part, lodging for authorized beneficiaries of the subscriptions.

4. The method of claim 3 wherein the lodging comprises, at least in part, private-lodging accommodations.

5. The method of claim 3 wherein the lodging comprises, at least in part, semi-private-lodging accommodations.

6. The method of claim 3 wherein the lodging comprises, at least in part, common non-private accommodations.

7. The method of claim 1 wherein the multi-person emergency shelter comprises, at least in part, food preparation facilities for authorized beneficiaries of the subscriptions.

8. The method of claim 1 wherein the multi-person emergency shelter comprises, at least in part, medical facilities for authorized beneficiaries of the subscriptions.

9. The method of claim 1 wherein the multi-person emergency shelter comprises, at least in part, water sanitation facilities for authorized beneficiaries of the subscriptions.

10. The method of claim 1 wherein the multi-person emergency shelter comprises, at least in part, environmental protection for authorized beneficiaries of the subscriptions.

11. The method of claim 10 wherein the environmental protection comprises protection from dangerous airborne contaminants as correspond to the civilly-catastrophic event.

12. The method of 11 wherein the dangerous airborne contaminants comprise at least one of:
radiological contaminants;
biological contaminants;
chemical contaminants.

13. The method of claim 12 wherein the dangerous airborne contaminants comprise each of:
radiological contaminants;
biological contaminants;
chemical contaminants.

14. The method of claim 1 wherein the multi-person emergency shelter comprises, at least in part, external-communication facilities.

15. The method of claim 1 wherein the multi-person emergency shelter comprises, at least in part, a controlled point of ingress.

16. The method of claim 1 wherein the multi-person emergency shelter comprises a positive air pressure capability to discourage airborne contaminants from entering the multi-person emergency shelter.

17. The method of claim 1 wherein the multi-person emergency shelter comprises an underground multi-person emergency shelter.

18. The method of claim 17 wherein the underground multi-person emergency shelter comprises a shelter that is covered by at least 2 meters of earth.

19. The method of claim 1 wherein the subscription provides a right of access for a stay comprising no more than a predetermined number of days.

20. The method of claim 19 wherein the predetermined number of days comprises about 30 days.

21. The method of claim 1 wherein the subscriptions are transferable to another subscriber.

22. The method of claim 21 wherein the subscriptions are conditionally transferable to another subscriber.

23. The method of claim 21 wherein the subscriptions are unconditionally transferable to another subscriber.

24. The method of claim 1 wherein the secure multi-person emergency shelter comprises accommodations that differ from one another and wherein the subscriptions differ from one another with respect to which accommodations are accessible as per the subscription.

25. The method of claim 1 wherein the secure multi-person emergency shelter comprises storage space.

26. The method of claim 25 wherein the consideration-based private civil security subscriptions also provide access to corresponding storage space.

27. The method of claim 1 wherein the consideration-based private civil security subscriptions is located proximal to at least one of:
an airstrip;
a helipad;
an open territory suitable to accommodate receiving an airborne passenger-carrying vehicle;
a port suitable to accommodate receiving a water-borne passenger-carrying vehicle.

28. The method of claim 27 wherein the airstrip comprises an airstrip that is reserved for receiving authorized beneficiaries of the subscriptions.

29. The method of claim 1 further comprising:
maintaining the secure multi-person emergency shelter pending a need to permit subscription-based access to the secure multi-person emergency shelter in event of a catastrophic event.

30. The method of claim 29 wherein maintaining the secure multi-person emergency shelter comprises maintaining a plurality of geographical remote secure multi-person emergency shelters and wherein a subscription provides civilly-catastrophic event-based access to more than one of the plurality of multi-person emergency shelters.

31. The method of claim 1 wherein a subscription provides civilly-catastrophic event-based access to any of the plurality of multi-person emergency shelters.

32. The method of claim 1 wherein accepting consideration-based private civil security subscriptions from subscribers with respect to providing civilly-catastrophic event-based access to a secure multi-person emergency shelter comprises:
assessing a likelihood of a least one particular civilly-catastrophic event occurring during a particular subscription term;
basing the consideration for the consideration-based private civil security subscriptions, at least in part, upon the likelihood.
